(19) United States
(12) Patent Application Publication
(10) Pub. No.: US 2025/0023112 A1
(43) Pub. Date: Jan. 16, 2025

(54) OPEN POOL BATTERY MODULE WITH PERMEABLE ELECTRODES

(71) Applicant: Eos Energy Technology Holdings, LLC, Edison, NJ (US)

(72) Inventor: Lukas Fuchshofen, Edison, NJ (US)

(73) Assignee: Eos Energy Technology Holdings, LLC, Edison, NJ (US)

(21) Appl. No.: 18/771,466

(22) Filed: Jul. 12, 2024

Related U.S. Application Data
(60) Provisional application No. 63/526,821, filed on Jul. 14, 2023.

(51) Int. Cl. H01M 10/36; H01M 4/02; H01M 4/583; H01M 10/38; H01M 50/103; H01M 50/121; H01M 50/15; H01M 50/16; H01M 50/507

(52) U.S. Cl. CPC H01M 10/365; H01M 4/583; H01M 10/38; H01M 50/103; H01M 50/121; H01M 50/15; H01M 50/16; H01M 50/507; H01M 2004/021; H01M 2004/027; H01M 2004/028

(57) ABSTRACT

A battery module that is a static, open pool single cell battery which may have electrode elements of the same polarity spaced apart but electrically connected in parallel to one another and suspended from a common bus into a common electrolyte pool, in addition to a battery box that receives a plurality of electrode elements into the common electrolyte pool for the open pool battery. The electrode elements are alternating cathode elements and anode elements. A method for manufacture of the battery module is also described.

### RELATED APPLICATIONS

This application claims priority to and the benefit of U.S. Provisional Application 63/526,821 filed Jul. 14, 2023, the disclosure of which is incorporated by reference herein in its entirety.

### TECHNICAL FIELD

The battery module described herein is a static, open pool battery which may have electrodes spaced apart but electrically connected in parallel to other electrodes of the same polarity and suspended from a common bus into a common electrolyte pool, in addition to a battery box that receives a plurality of electrode elements into the common electrolyte pool for the open pool battery.

### BACKGROUND

Batteries with liquid electrolytes therein present inherent challenges for sealing the electrolyte both into the battery itself and into individual cells within the battery. Specifically, such sealed battery designs are difficult to manufacture at low cost and with high manufacturing throughput. In one earlier design, bipolar battery electrodes are assembled by joining separate modular subassemblies of cells or frames together in a manner repeated over the desired number of cells in series for the bipolar electrode stack. Isolation both between adjacent cells and between cells and the environment external to the battery is accomplished using a variety of joining methods, including compression type seals, infrared welding, laser welding, vibration welding, or adhesive type seals. This assembly paradigm limits options for manufacturing and automation, may have poor overall yields due to externally facing seals and may have a number of consecutive subprocesses during assembly of a single stack. Multiple assembly steps require high levels of process control and tolerancing due to the number of modular parts assembled together, and adds cost to the battery due to the large number of complex modular parts that must be molded or otherwise manufactured. Additionally, all of the above-mentioned joining methods are typically completed using rigid metal electrodes within the frames, where the metal electrodes may provide chemical, thermal and mechanical resistance to the assembly processes.

In one aspect of the earlier designs, the bipolar electrodes are formed of conductive plastic electrodes. Other proposed battery designs for conductive plastic electrodes require the frame or battery casing to be co-injection molded with the conductive plastic electrode. However, the challenge with this technique is it severely limits the materials which can be used for the conductive plastic electrode as only a small subset of materials is capable of being injection molded.

Historically, the biggest challenges to the implementation of bipolar batteries are related to sealing of the individual cells, both from the external environment and internally between adjacent cells. In designs where the individual cells are welded together, there is a need for strong welds over large surface areas and in a repeated manner for sealing the battery from the external environment, and on gaskets or seals for sealing adjacent cells internally. These sealing strategies may have high manufacturing variability, long assembly times, and require large amounts of equipment for assembly. The construction of a battery with multiple cells may also require the use of separators, which adds to battery size, cost and complexity of design.

Also, in battery constructions with conductive plastic electrodes, the conductive plastic electrode materials with the best performance must also have a high proportion of conductive diluents relative to the amount of plastic. Such conductive diluents typically contain carbon, graphite, metal, or other conductive materials. When the volume fraction of such diluents is high relative to the lower melting polymer it becomes difficult to weld them together or injection mold them. Therefore, simpler and less expensive constructions and methods of construction for batteries that use liquid electrolytes are sought, which are also more amenable to the materials and methods used to construct such batteries at lower cost.

### BRIEF SUMMARY

Described herein is a static, open pool battery module which may have conductive electrodes of the same polarity electrically connected to one another via a common bus and suspended from the bus into a common electrolyte pool, in addition to a battery box that receives the suspended electrodes into the common electrolyte pool. There is no division or separation of the electrolyte among the common electrodes. The open pool battery electrolyte may be a zinc bromine electrolyte, although other electrolytes are contemplated. Because all electrodes are suspended in a common electrolyte pool and not sealed from one another, a single high-capacity cell is formed. Such a construction simplifies battery design and battery manufacture, since only one cell is required for each module. The module may be a single battery or there may be multiple modules in a battery energy storage system (BESS).

While flow batteries often share common electrolyte pumped through multiple cells, static batteries historically have been designed to operate such that the electrolyte of every single cell is physically/mechanically isolated from adjacent cells in the module.

Unlike bipolar batteries, the open pool battery construction described herein does not have seals within the pool (the battery housing is described as a bathtub for the electrolyte) that define discrete battery cells. The alternative construction provides the same energy density for the same quantity of active material as a bipolar design (bipolar electrodes have a cathode on one side and an anode on the other), but does not require sealed electrodes that form individual battery cells. This design removes a key cost driver, a key point of failure, and an entire sub-assembly from the prior battery designs with multiple cells. Consequently, this design allows for a simpler, more robust, and more cost-effective battery without sacrificing performance. Also, in this design, each porous electrode element has an opposite polarity electrode element to either side, as opposed to just one side in a traditional bipolar design, this design therefore makes better use of the entire porous electrode elements, the use of which may otherwise be heavily skewed towards the face nearest the opposite polarity electrode. This effect, together with the fact that the dimensions and spacing of the electrode elements can be easily adjusted to achieve a desired performance in this design, enables reliable battery performance without the need for a separator between the anode and the cathode elements (traditionally a porous membrane between the anode and cathode that is permeable to select ions but impermeable to other ions and/or molecules). This simplifies battery construction and also reduces the cost of constructing the battery without compromising battery performance. The simplicity derives from the fact that multiple distinct anode electrode elements and multiple distinct cathode electrode elements all share a common electrolyte within a static battery cell. Shared electrolyte access among all of the electrodes is achieved by designing the electrodes to be porous and eliminating separators that are a staple of static battery constructions with multiple anode/cathode electrode pairs. The advantage of this construction over prior designs is that it allows single cells to contain a large amount of electrode material and be extremely high capacity, while also minimizing manufacturing complexity and eliminating the need for mechanical seals between cells.

Aspects of the present disclosure provides a sealed battery housing (i.e., a “battery box” herein) which houses the electrode elements within a common electrolyte pool and a method for its assembly. The battery box may be formed from a non-conductive elastomer or resin. The non-conductive battery box can be formed using conventional techniques such as, for example, injection molding, extrusion, blow molding, rotational molding, etc. The interior of the bipolar battery box is configured to accept electrode elements in a manner where one continuous electrolyte pool is formed across the entire battery box. In one aspect the battery box contains a plurality of dividers extending laterally across the width of the battery box. The dividers (and the electrode elements received in them) are housed in the battery box, which has a plurality of longitudinal walls, a plurality of lateral walls, a bottom wall, and a top portion. The dividers are not seals. The dividers ensure that the electrodes do not contact each other, since such contact could short the battery. The electrode elements can be either cathodes or anodes. In one aspect, the battery has a plurality of cathode elements bused together on a common cathode bus and a plurality of anode elements bused together on a common anode bus. This forms a single cathode and a single anode that are electrically continuous, but physically separated into multiple elements. This effectively wires the individual elements of a kind in parallel instead of series, forming a high current battery instead of a high voltage battery. Therefore, the battery will have the voltage of a single electrode, but it can sustain the current equal to the sum of the individual electrode elements.

In some aspects, the battery box is a single piece (i.e. molded) box composed of non-conductive composite resin that has an open interior for receiving the electrode elements and other battery components therein. The non-conductive resin is a blended composite of one or more non-conductive polymers, which may include polypropylene, high density polyethylene, polystyrene, polyphenylene oxide, polyvinylchloride or polyphenylene ether or any other suitable thermoplastic materials that are chemically compatible with the electrolytes used in battery devices. The material may be further compounded with structural fillers (including glass fiber, glass bead, or silica fume), pigmenting materials (including carbon black or titania), or flame retardants. In some aspects, the battery box may be injection molded or machined. In some aspects, the non-conductive composite resins might be a multilayer coated article. In those aspects, the battery box substrate or base is not required to be thermoplastic.

The battery box houses a plurality of electrode elements, i.e., at least one anode element and at least one cathode element. To realize the advantages of this design, a construction with multiple cathode elements and multiple anode elements is contemplated. In one aspect, at least some of the electrode elements have a component constructed of a thin piece of non-conductive plastic containing holes to allow for ion transport, with an electrode material attached to both sides via methods such as heat pressing. In one aspect, the material used for the cathode is graphite felt, or similar graphitic material with a high surface area. In one aspect, the material used for the anode element or the cathode element is carbon cloth or carbon foam. In addition to being high surface area, the electrode material is also porous to allow the material to be thoroughly wetted by the electrolyte. Consequently, the electrolyte contained within the open pool battery is in contact with every electrode element due to the porosity of the electrode elements. Consequently, the battery box has at least two adjacent “cells” (i.e., an anode element and a cathode element separated by electrolyte) that are physically separated but are disposed in a common pool of electrolyte (i.e. there is no physical separation of the electrolyte from cell to cell).

In another aspect, at least one or more of the electrode elements are constructed using a single piece of porous carbon or graphite material that is not affixed to a perforated plastic substrate. In this aspect, the amount of material used will be minimal, but the electrode elements are sufficiently immobilized to prevent the excess movement of any soft electrodes, such as felt, which would risk a short should a cathode come in contact with an anode or vice-versa. In this aspect, the side dividers in the bathtub defined by the housing that are described herein are useful to keep the electrodes separated. Additionally, an electrical connection is required between the electrode element and the bus at the top of the battery box. Examples of the bus include a wire or a bar.

In the aspect where the interior of the battery housing has dividers, each electrode element is received into a slot defined by dividers. The dividers do not segregate the electrolyte in any way, as the electrodes are all suspended from the bus into the common electrolyte. The dividers are provided simply to ensure that the adjacent electrodes do not come into physical contact that would cause a battery short circuit.

The conductive material used in the electrode elements can serve as both the electrode surface and a current collector that can transport the current to the top of the cell (i.e., to the common bus). Current collectors may have a variety of configurations. Whatever configuration is selected will allow the current collector to be received into the top of the battery box.

Described herein is method for assembling a battery with housing formed from a non-conductive plastic. As such the housing can be molded or formed from other techniques such as 3D printing, welding, etc. In one aspect, the battery box housing defines a bathtub that will hold electrolyte therein. The bathtub may have non-conductive dividers extending from the sides of the bathtub interior. The gaps between dividers receive either an anode element or a cathode element therebetween. In one aspect, the electrode assembly is pre-formed by fixing the electrode elements to the common bus structure. The common bus structure has a Cathode Bus and an Anode Bus. The cathode elements are electrically connected and structurally affixed to the Cathode Bus but insulated from and structurally affixed to the Anode Bus. The anode elements are electrically connected and structurally affixed to the Anode Bus but insulated from and structurally affixed to the Cathode Bus. Conductive and non-conductive adhesives for fixing the electrode elements to the cathode bus and anode bus are well known to one skilled in the art and are not described in detail herein. The electrode elements may also be affixed to the bus elements by sintering or welding.

The electrolyte may be added to the open pool battery box either before or after the electrode assembly is assembled to the battery box housing. In one aspect, the lid is placed on the battery box after the bathtub has received the electrolyte, and the electrode assembly is then assembled with the battery box. In another aspect, the electrode assembly may be assembled to the battery box and the electrolyte added thereafter. In yet another aspect, the electrode assembly may be pre-formed with the battery lid and placed on the battery box either before or after the electrolyte is added to the bathtub. The lid can be affixed to the battery box by any conventional method such as welding, thermoforming, adhesive, etc.

### BRIEF DESCRIPTION OF DRAWINGS

The drawings described herein are for illustrative purposes only of selected configurations and are not intended to limit the scope of the present disclosure.

FIG. is a perspective view of a molded battery box with electrode dividers according to one aspect of the open pool battery assemblies described herein.

FIG. 2 is a perspective view of a molded battery box without dividers.

FIG. 3A to FIG. 3D are perspective views of a lid assembly, as the lid assembly is populated with electrode elements.

FIG. 4 illustrates the completed lid/electrode assembly being inserted into the battery box of FIG. 2.

FIG. 5 is a perspective view of the electrode assembly with the molded battery box shown in phantom.

FIG. 6 illustrates a graph showing voltage (top) and current (bottom) for test cycle with an open pool cell battery described herein.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “joined to,” or “coupled to” another element or layer, it may be directly on, engaged, connected, joined, or coupled to the other element or layer, or intervening elements or layers may be present. In contrast, when an element is referred to as being “directly on,” “directly engaged to,” “directly connected to,” “directly joined to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The terms upper, lower, above, beneath, right, left, etc. may be used herein to describe the position of various elements with relation to other elements. These terms represent the position of elements in an example configuration. However, it will be apparent to one skilled in the art that the frame assembly may be rotated in space without departing from the present disclosure and thus, these terms should not be used to limit the scope of the present disclosure.

As used herein, the term “battery” encompasses electrical storage devices comprising at least one electrochemical cell.

As used herein, the term “electrochemical cell” or “cell” are used interchangeably to refer to a device capable of either generating electrical energy from chemical reactions or facilitating chemical reactions through the introduction of electrical energy.

As used herein, an “electrolyte” refers to a substance that behaves as an ionically conductive medium. For example, the electrolyte facilitates the mobilization of electrons and cations in the cell. Electrolytes include mixtures of materials such as aqueous solutions of metal halide salts (e.g., ZnBr₂, ZnCl₂, or the like).

As used herein, the term “electrode element” refers to an individual conductive component of an electrode assembly. An electrode element may also refer to either an anode element or a cathode element.

As used herein in, the term “anode element” refers to the negative electrode element from which electrons flow during the discharging phase in the battery. The anode element is also the electrode element that undergoes chemical oxidation during the discharging phase. However, in rechargeable cells, the anode element is the electrode element that undergoes chemical reduction during the cell's charging phase. Anode elements are formed from electrically conductive or semiconductive materials, e.g., conductive plastics or composites, metals (e.g., titanium or aluminum, etc.), metal oxides, metal alloys, metal composites, semiconductors (e.g., TiC, SiC), or the like. The anode element may be porous to allow electrolyte to flow through the anode element, thoroughly wetting the surface area of the anode element.

As used herein, the term “cathode element” refers to the positive electrode into which electrons flow during the discharging phase in the battery. The cathode element is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., conductive plastics or composites, metals (e.g., titanium or aluminum, etc.), metal oxides, metal alloys, metal composites, semiconductors (e.g., TiC, SiC), or the like. In one aspect, the cathode element has a component constructed of a thin piece of non-conductive plastic that is at least somewhat perforated to allow for the flow of electrolyte therethrough thereby increasing the surface area of the cathode element wetted by the electrolyte.

The term “electrode assembly” refers to an assembly having a plurality of electrode elements wherein a first portion of the electrode elements are electrically connected to a common anode bus and are at the same potential and a second portion of the electrode elements are electrically connected to a common cathode bus and are at a common potential.

In a further aspect, the cathode element may at least contain a substrate constructed of a thin piece of non-conductive plastic containing holes to allow for ion transport, with a porous electrode material attached to both sides. The anode element may be formed from an electrode material similar to the electrode material of the cathode element, but the electrode material for the anode elements is optionally porous. The assembly has the porous electrodes affixed to the bus. The electrodes may be welded or sintered. Any method of affixation is contemplated as suitable. Electrode elements provide an electrochemically active surface.

If the conductive material for the anode element/anode element is porous, the extent of the porosity is largely a matter of design choice. One of skill in the art will understand that, if the electrolyte is going to freely flow through and wet the conductive materials, then the conductive materials need to have a significant amount of open volume in support of this objective. There will be a trade off in open volume vs. performance (in terms of the degree to which charge is exchanged between the electrode materials and the electrolyte). In this regard, electrode materials with at least about 50 percent open volume are contemplated. In some aspects, the open volume of the conductive material is about eighty (80) percent to about ninety-nine (99) percent. In other aspects, the open volume of the electrode materials may be about ninety (90) percent to about ninety-five (95) percent. In one aspect, the open volume of the cathode conductive material is about ninety (90) percent to about ninety-five (95) percent

### II. Exemplary Structure

Described herein is a battery that deploys an electrode assembly having electrode elements constructed of a thin piece of non-conductive plastic upon which is disposed a high surface area material such as graphite felt, carbon cloth, carbon foam, etc. The electrode elements are suspended from a common bus structure in a non-conductive battery box that holds a common pool of electrolyte into which the electrode elements are at least partially immersed. The battery described herein has a design that mitigates the challenges of multi-cell battery constructions that require seals and spacers between the individual cells. The single cell construction requires only one common pool of electrolyte into which all of the electrode elements are suspended from a common bus. In one aspect, the individual electrode elements are received into side slots defined by non-conductive dividers. The dividers do not segregate the electrolyte nor create individual battery cells. The dividers simply prevent contact between adjacent anode/cathode elements. In one aspect, the electrode assembly of electrodes, Cathode Bus, Anode Bus and lid is pre-formed and affixed as a single assembly to the non-conductive battery box housing. The lid is sealed to the housing but the Cathode Bus and Anode Bus extend from the housing to allow the battery to be electrically connected to other devices or systems.

This design reduces cost and simplifies battery manufacture by reducing the number of total components to be manufactured for the battery casing or by relaxing requirements on material properties for components. As the design allows for assembly without sealing the individual electrode elements, the design also allows for greater flexibility than when rigid metal electrodes, softer conductive plastic electrodes, or other bipolar electrode materials are used in battery assemblies. Collectively, these advantages allow for improved manufacturing yield, simpler manufacturing, and reduced overall cost of the battery relative to other designs.

In one aspect, described herein is a design for a static open pool battery having one electrochemical cell within a molded box and a method for assembling such a battery. In one aspect, the electrolyte is zinc bromine, but other electrolytes (e.g. zinc halide, etc.) are contemplated. Zinc chloride, zinc iodide, or combinations of different halides are possible. This design could also function with other aqueous electrolytes of sufficiently high conductivity. Aqueous electrolytes with sufficient conductivity are well known to one skilled in the art and are not described in detail herein. Examples include electrolytes that release ions such as Na, Zn, K, Mg, Ca and Al. See Zhang, H., et al., “Challenges and Strategies for High-Energy Aqueous Electrolyte Rechargeable Batteries” Angew. Chem. Int., Vol. 60, pp 598-616 (2021), the disclosure of which is incorporated by reference herein.

After filling the battery box with electrolyte, the lid carrying the electrode assembly may be welded (or otherwise joined) onto the top of the molded box containing the electrodes. This design creates an open pool battery which cannot leak electrolyte out of the bottom or sides, as all electrodes are enclosed in the molded box and only the top is scaled (i.e., there are no potential leakage pathways through the bottom or sides of the battery box which is of molded, unitary and monolithic construction). Additionally, this design may be manufactured efficiently, compared to assembly processes for multi-cell batteries.

While a zinc bromine battery is described herein, such description is illustrative, and not limiting. The battery design and method of manufacture described herein may be used with any aqueous salt based static (i.e., non-flow) zinc halide electrolyte battery chemistry.

Also, although the battery box is described herein as made by molding or injection molding, the battery box may be manufactured by machining or any other suitable and conventional technique for fabricating plastic articles. Molding is a low-cost method with higher manufacturing throughput.

There are multiple different sizes and shapes for the box and for dividers that will hold the electrodes apart without segregating the electrolyte. The number of dividers that may be included in the battery box and their orientation are largely a matter of design choice, and depends upon the number of electrodes that need to be held apart. Different methods for making external electrical contact with the Anode Bus and Cathode Bus are contemplated. Multiple different methods of attaching/sealing the lid to the battery box after the electrodes have been inserted and filled with electrolyte are also contemplated. Multiple different methods of creating a vent or pressure relief valve in the lid on the box are contemplated. Multiple methods of assembling the perforated, non-conductive plastic electrode substrates to the high surface area graphite felt/carbon cloth/carbon foam thereto are contemplated. As previously stated, the conductive electrode materials may be porous to allow the electrolyte to freely flow through and wet the high surface area conductive materials assembled to the perforated non-conductive plastic electrode substrates. Multiple methods of attaching the carbon material to the non-conductive plastic electrodes prior to inserting the electrodes into the box are contemplated. However, the battery box is now described in illustrative aspects.

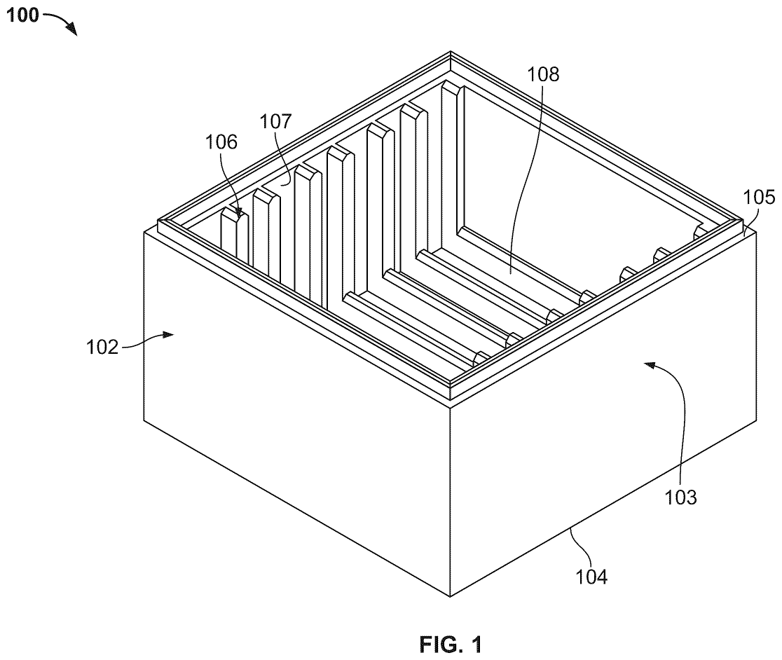

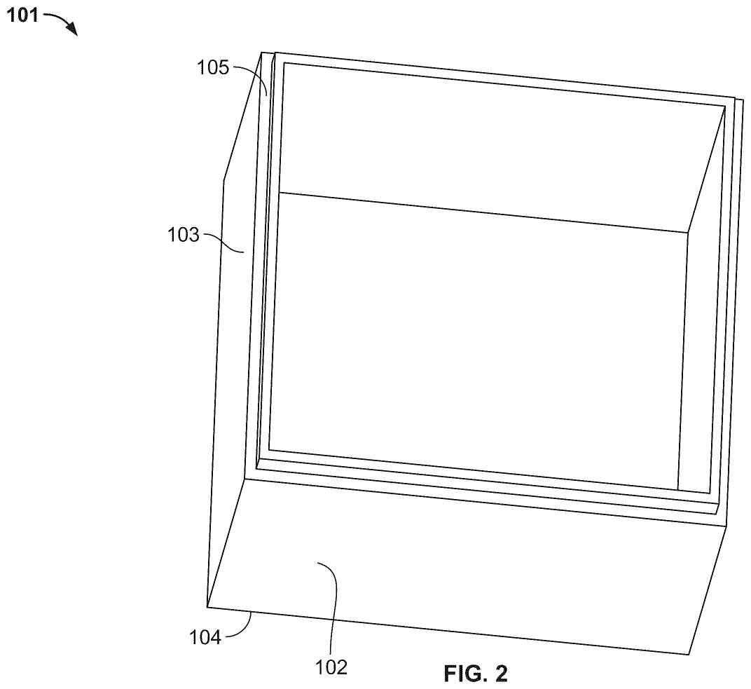

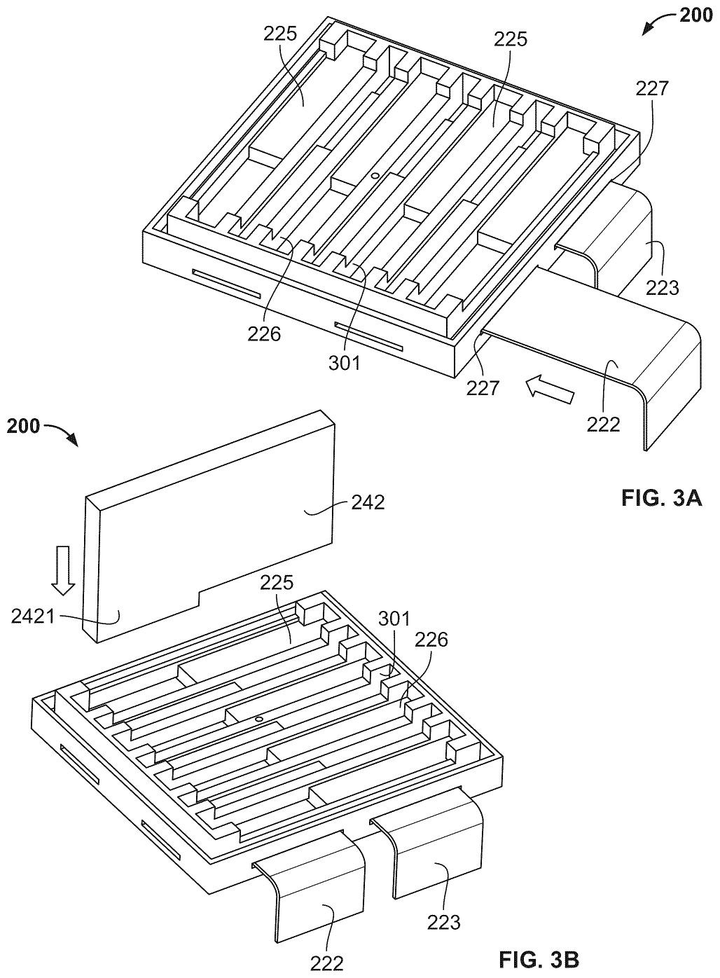

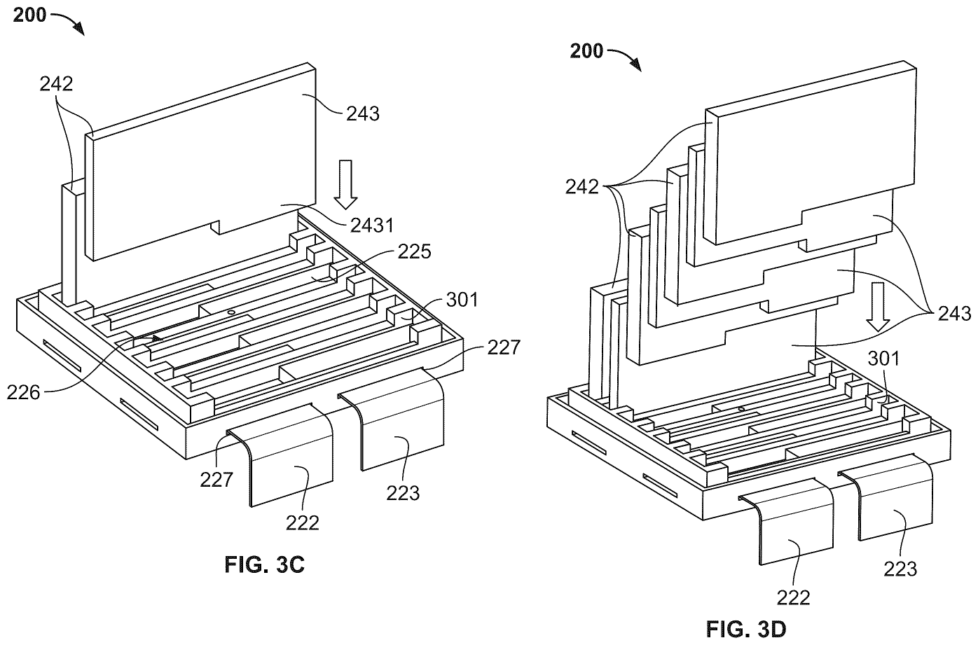

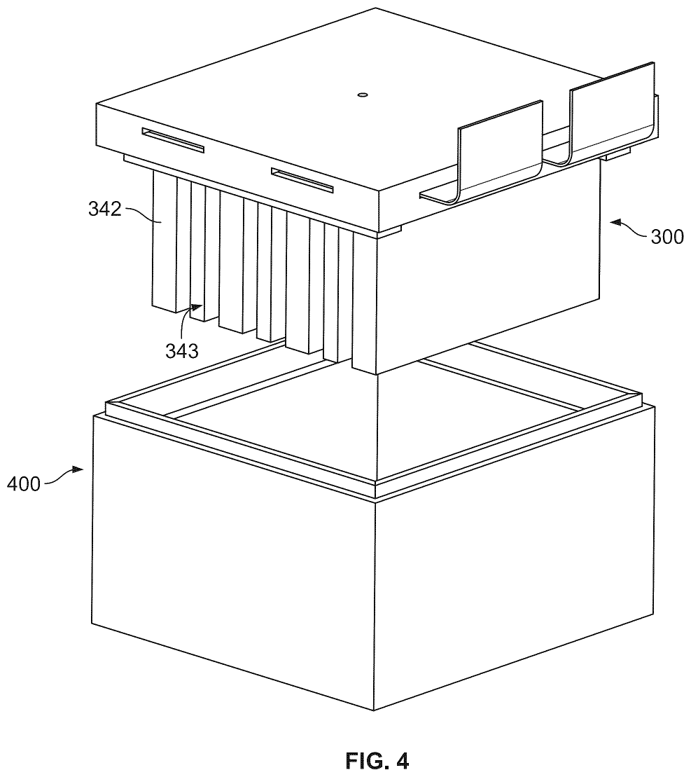

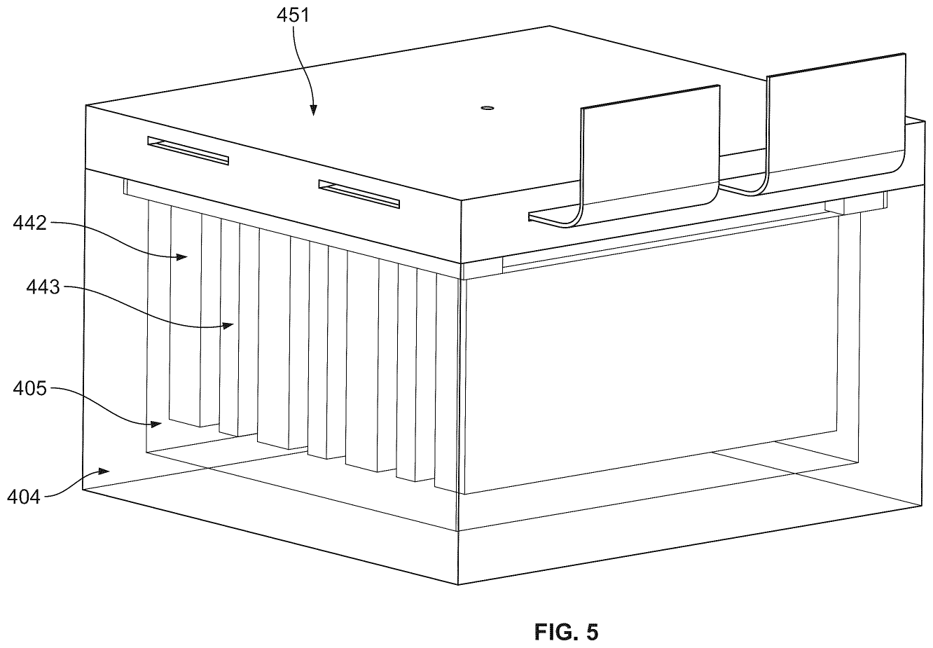

As illustrated below, two aspects of the battery box are illustrated in FIGS. 1 and 2. FIGS. 3A-3D is a bottom view of the electrode assembly to be received by the battery box of FIG. 2 as it is being assembled. FIG. 4 is a perspective view of the electrode assembly of FIGS. 3A-3D as it is being inserted into the molded battery box. FIG. 5 is the assembled open pool battery.

After assembly, the lid is sealed to the battery box, with the electrode assembly suspended from the portion of the lid facing the interior of the battery box. FIG. 4 also illustrates the battery box lid, with the Anode Bus and Cathode Bus extending from the lid for external electrical connection.

Referring to FIG. 1, a molded battery box 100 containing a plurality of dividers 106 enclosed within a plurality of longitudinal walls 102 is illustrated. Length, as used herein, is the direction across an individual cell, while width is in the direction of cell stack. The molded battery box also has a plurality of lateral (e.g., sidewalls) walls 103, a bottom wall 104, and a top portion 105. Each divider 106 provides a small partial partition that will keep the anodes/cathodes from coming into physical contact causing a battery to short. The dividers form side slots 107 that do not segregate the electrolyte which is held in a common reservoir in which all of the electrodes are at least partially immersed. The molded battery box may also have dividers 108 at the bottom thereof.

An alternate embodiment of a molded battery box 101 is illustrated in FIG. 2. The molded battery box also has longitudinal sidewalls 102, lateral walls 103, sidewalls 103, a bottom wall 104 and a top portion, but lacks the dividers illustrated in FIG. 1.

Referring to FIGS. 3A-3D, a bottom view of an electrode assembly 200 for the open pool battery molded box (FIG. 5) that, when assembled has a plurality of cathode elements 242 and anode elements 243. The battery box into which the electrode assembly is received is a non-conductive box-like structure composed of non-conductive composite resin. For example, the non-conductive resin may be a blended composite of one or more non-conductive polymers, which may include polypropylene, high density polyethylene, polystyrene, polyphenylene oxide, or polyphenylene ether. The material may be further compounded with structural fillers (including glass fiber, glass bead, or silica fume), pigmenting materials (including carbon black or titania), or flame retardants. In some embodiments, the battery box may be formed by injection molding or may be machined, 3D printed, or formed by other conventional methods for forming such structures.

In the electrode assembly illustrated in FIGS. 3A-3D, the cathode elements 242 are electrically connected and physically affixed to Cathode Bus 222 and physically fixed but electrically isolated from Anode Bus 223. The anode elements 243 are electrically connected and physically affixed to Anode Bus 223 and physically fixed but electrically isolated from Cathode Bus 222. The cathode elements are provided with a tab 2421 that contacts the Cathode Bus 222. The rest of the cathode elements 242 rest on a spacer 225 that electrically isolates the cathode elements from the Anode Bus 223. Similarly, the anode elements 243 are provided with a tab 2431 that contacts the Anode Bus 223. The rest of the anode elements 243 rest on a spacer 225 that electrically isolates the anode elements 243 from the Cathode Bus 222. The cathode elements 242 and the anode elements 243 are received into electrode receptacles 226 defined by shallow dividers formed in the electrode assembly 200. The electrode assembly 200 also has notches 227 into which the Cathode Bus 222 and the Anode Bus 223 are received. As can be seen in FIG. 3B, the electrode assembly 200 only leaves the Cathode Bus 222 and Anode Bus 223 exposed where contact is to be made with the respective tabs 2421 and 2431 of the cathode elements 242 and the anode elements 243.

Referring to FIG. 4, illustrated is a perspective view of the electrode assembly 300 as it is about be assembled to the battery box 400. FIGS. 3A-3D illustrates the electrode assembly molded battery box wherein the cathode elements 342 and anode elements 343 are separated by shallow dividers 301 formed in the electrode assembly 200. As described above, each of the cathode elements 342 are bused together using the Cathode Bus 322 and each of the anode elements 343 are bused together using the Anode bus 323. As noted above, cathode elements 342 and anode elements 343 are permeable and preferably very permeable. As described here, the permeable electrode materials are described as having an open volume or porosity. In one aspect the cathodes and anodes have a non-conductive perforated substrate that is typically plastic. As noted above, the cathode elements are formed by depositing a high surface area graphite felt onto the perforated plastic substrate. The anode elements are formed by depositing carbon cloth or carbon foam on the non-conductive, perforated plastic substrates.

Referring to FIG. 5, in some aspects, the electrode assembly illustrated in FIGS. 3A-3D is inverted and the top cover 451, from which the cathode elements 442 and anode elements 443 are suspended, is placed on the battery box housing 404 to form the battery. Within the housing 404 is the pool 405 the contains the common electrolyte in which the cathode elements 442 and the anode elements 443 are immersed. As noted above, the battery box interior may have side partitions to ensure that adjacent electrode elements do not contact each other. The battery box pool 405 receives the electrolyte and the cathode elements 442 and anode elements 443 are received into the common electrolyte pool. The lid may be a solid piece of non-conductive resin of appropriate size to close the battery casing. The lid may be sealed to the battery casing and external terminals after assembly by a sealing material (e.g., a compression seal, an elastomer, a glue, etc.) or infrared, vibration, laser, or other known method of plastic welding. Sealing materials for the battery box are well known and not described in detail herein. Suitable sealing materials provide a liquid/gas tight seal so that electrolyte and head space gases do not escape from the sealed battery box. The battery lid may contain additional features to facilitate filling the common electrolyte pool with electrolyte.

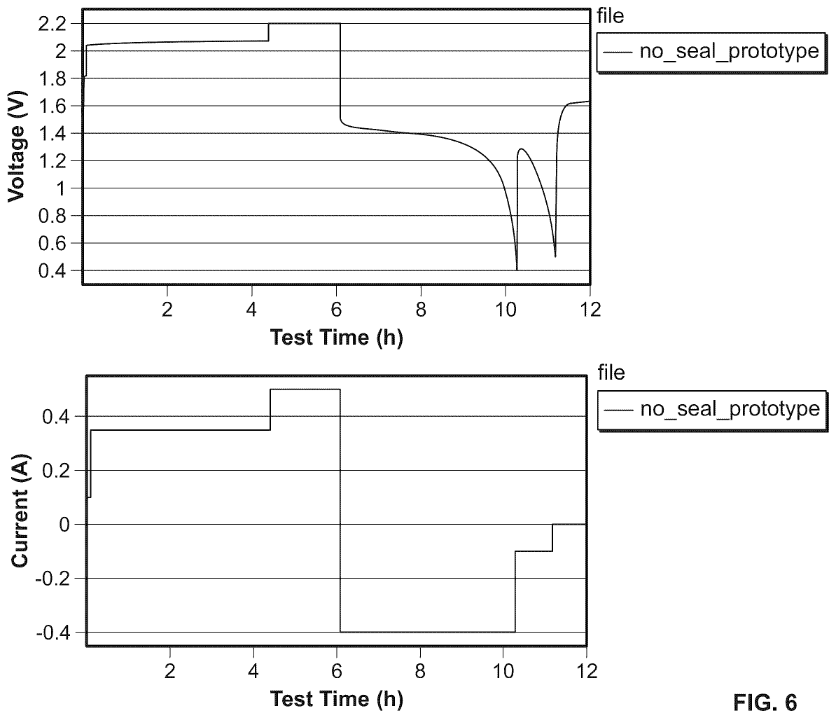

FIG. 6 illustrates two graphs showing voltage (top graph) and current (bottom graph) as a function of test time. FIG. 6 demonstrates the efficacy of the battery design having a single common electrolyte pool described herein.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

Although specific advantages have been enumerated above, various embodiments may include some, none, or all of the enumerated advantages.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

What is claimed is:

1. A single cell battery comprising:
a non-conductive housing that defines a cell, the non-conductive housing being configured to receive a lid thereover;
an electrode assembly comprising a plurality of cathode elements and a plurality of anode elements, the cathode elements optionally comprising a perforated non-conductive substrate to which a high surface area conductive material is affixed and the anode elements optionally comprising a perforated non-conductive substrate to which a high-surface area conductive material is affixed, wherein the anode elements and cathode elements are supported by and extend from a common Cathode Bus and a common Anode Bus, wherein the cathode elements are electrically and physically connected to the Cathode Bus and electrically insulated from the Anode Bus and wherein the anode elements are electrically and physically connected to the Anode Bus and electrically insulated from the Cathode Bus;
a reservoir that contains a common electrolyte in which all of the cathode elements and anode elements are at least partially immersed in the common electrolyte; and
a lid from which the electrode assembly extends into the cell defined by the housing, wherein the lid is affixed to the housing such that external electrical connections can be made to the Cathode Bus and the Anode Bus and wherein the lid is affixed to the housing to form a liquid tight seal.

2. The single cell battery of claim 1, wherein the high-surface area conductive material is porous.

3. The single cell battery of claim 2, wherein the high surface area conductive cathode material is porous.

4. The single cell battery of claim 3, wherein the anode comprises an electrically conductive or semiconductive material.

5. The single cell battery of claim 4, wherein the conductive anode material is selected from the group consisting of a conductive plastic, a conductive composite, a metal a metal oxide, a metal alloy, and a metal composite.

6. The single cell battery of claim 4, wherein the anode semiconductor material is selected from TiC or SiC.

7. The single cell battery of claim 5, wherein the metal is one of titanium or aluminum.

8. The single cell battery of claim 5, wherein the conductive composite is selected from the group consisting of a carbon felt, porous carbon, carbon cloth, carbon foam and graphitized forms of the conductive composites.

9. The single cell battery of claim 4, wherein conductive anode material is porous.

10. The single cell battery of claim 9, wherein the porous conductive material has an open volume of at least about fifty percent.

11. The single cell battery of claim 10, wherein the porous conductive material has an open volume of at least about eighty percent to about ninety-nine percent.

12. The single cell battery of claim 3, wherein the porous cathode material is supported on a perforated, non-conductive substrate.

13. The single cell battery of claim 12, wherein the porous cathode material is selected from the group consisting of a carbon felt, porous carbon, carbon cloth, carbon foam and graphitized forms of the conductive composites.

14. The single cell battery of claim 13, wherein the porous cathode material has an open volume of at least about fifty percent.

15. The single cell battery of claim 14, wherein the porous cathode material has an open volume of at least about eighty percent to about ninety-nine percent.

16. The single cell battery of claim 15, wherein the porous conductive material has an open volume of at least about ninety percent to about ninety-five percent.

17. The single cell battery of claim 12, wherein the non-conductive substrate is selected from the group consisting of polypropylene, high density polyethylene, polystyrene, polyphenylene oxide, and polyphenylene ether.

18. The single cell battery of claim 1, wherein the housing and the lid are formed of a non-conductive plastic.

19. The single cell battery of claim 1, wherein the cell in the housing has a bottom surface and sidewalls, wherein a plurality of dividers extend from at least one of the bottom or the sidewalls, wherein the dividers define slots that prevent contact between a cathode and adjacent anode but do not prevent the electrolyte from contacting all of the electrode elements and the cathode elements.

20. The single cell battery of claim 1, wherein an electrolyte is present in the electrolyte reservoir.

21. The single cell battery of claim 20, wherein the electrolyte is a zinc halide solution.

22. The single cell battery of claim 20, wherein the electrolyte releases metal ions selected from the group consisting of sodium (Na⁺), Zinc (Zn⁺), potassium (K⁺), Magnesium (Mg⁺), Calcium (Ca⁺) and aluminum (Al⁺).

23. The single cell battery of claim 1, wherein there are no physical barriers in the electrolyte reservoir that electrically isolate a portion of the common electrolyte from another portion of the common electrolyte.

24. A method of assembling a single cell battery comprising:
providing a non-conductive housing that defines a cell, the non-conductive housing being configured to receive a lid thereover;
providing an electrode assembly comprising a plurality of cathode elements and a plurality of anode elements, the cathode elements optionally comprising a perforated non-conductive substrate to which a high surface area conductive material is affixed and the anode elements optionally comprising a perforated non-conductive substrate to which a high-surface area conductive material is affixed, wherein the anode elements and cathode elements are supported by and extend from a common Cathode Bus and a common Anode Bus, wherein the cathode elements are electrically and physically connected to the Cathode Bus and electrically insulated but physically connected to the Anode Bus and wherein the anode elements are electrically and physically connected to the Anode Bus and electrically insulated by and physically connected to the Cathode Bus;
adding an electrolyte into a single electrolyte reservoir in which all of the cathode elements and anode elements are at least partially immersed; and
providing a lid from which the electrode assembly extends into the cell defined by the housing, wherein the lid is affixed to the housing such that external electrical connections can be made to the Cathode Bus and the Anode Bus and wherein the lid is affixed to the housing to form a liquid tight seal.
